(19) United States
(12) Patent Application Publication
(10) Pub. No.: US 2017/0356351 A1
(43) Pub. Date: Dec. 14, 2017

(54) CONTROL APPARATUS

(71) Applicant: DENSO CORPORATION, Kariya-city (JP)

(72) Inventors: Yuuki KAWAI, Kariya-city (JP); Daiji ISOBE, Kariya-city (JP)

(21) Appl. No.: 15/538,395

(22) PCT Filed: Dec. 8, 2015
(86) PCT No.: PCT/JP2015/006076

§ 371 Date: Jun. 21, 2017

(30) Foreign Application Priority Data
Dec. 24, 2014 (JP) 2014-260065

(51) Int. Cl. F02D 13/02; F02D 41/36; F02D 45/00; F02D 41/10; F02D 43/00; F02D 41/40; F02D 1/16

(52) U.S. Cl. CPC F02D 13/0211; F02D 41/10; F02D 41/365; F02D 43/00; F02D 45/00; F02D 1/162; F02D 41/401; F02D 2250/12

(57) ABSTRACT

A control value calculation part includes an in-cylinder state estimation part that estimates a state to which the cylinder belongs between a plurality of PM-PN generation states. The plurality of PM-PN generation states are states in which a particulate matter is easily generated as compared with the other state, and are different from each other in a cause to generate the particulate matter. Further, in a case where it is determined that an operation state of an engine is a PM-PN exhaust state, the control value calculation part calculates a control value of an actuator in such a way to eliminate the PM-PN generation state according to the PM-PN generation state to which the state in the cylinder belongs.

### CROSS-REFERENCE TO RELATED APPLICATIONS

This application is based on Japanese Patent Application No. 2014-260065 filed on Dec. 24, 2014, the disclosure of which is incorporated herein by reference.

### TECHNICAL FIELD

The present disclosure relates to a control apparatus that controls an internal combustion engine to directly inject fuel into a cylinder mounted in a vehicle.

### BACKGROUND ART

There has been widely used an internal combustion engine of a direct injection type in which fuel is directly injected into a cylinder. In the internal combustion engine of this type, as compared with an internal combustion engine of a type in which the fuel is injected into an intake port, it is concerned that a particulate matter (PM) is discharged and that the number of particulate matters (PN) is increased. At a time of a transient operation when an operation state of the internal combustion engine is in transition, in particular, it is markedly concerned that the PM is discharged and that the PN is increased.

As causes to generate the PM and to increase the PN are considered that the fuel is attached to an interior of the cylinder and that the fuel becomes nonuniform in the cylinder. In short, when the fuel is directly injected into the cylinder, the fuel is attached to the cylinder and a piston as it is liquid. Further, the fuel and air are not sufficiently mixed with each other in the cylinder, so that the fuel becomes partially rich in the cylinder. Hence, as a countermeasure against the generated PM and the increased PN in the internal combustion engine of a direct injection type, it is supposed to be effective that the fuel in the liquid state is restrained from being attached to the interior of the cylinder and that a mixing of the fuel and the air is accelerated.

In Patent Literature 1, as a control apparatus of an internal combustion engine of a direct injection type, a control apparatus is disclosed which changes a setting of an operation of an internal combustion engine so as to restrain fuel in the liquid state from being attached to the interior of the cylinder. In more detail, the control apparatus disclosed in Patent Literature 1 temporarily changes a fuel injection timing to thereby reduce the fuel attached to the interior of the cylinder as it is liquid.

However, even if the fuel injection timing is changed, it is not avoided that the fuel becomes nonuniform in the cylinder. Hence, only by a method of changing the fuel injection timing, it is difficult to sufficiently restrain the PM from being generated and the PN from being increased at the time of a transient operation of the internal combustion engine.

Further, in the control apparatus disclosed in Patent Literature 1, an effect of a state of the internal combustion engine such as temperature is not taken into account at the time of changing the fuel injection timing. The temperature of the internal combustion engine has an effect on the PM being generated and the PN being increased, so that also in this point of view, it is considered that the control apparatus disclosed in Patent Literature 1 cannot sufficiently restrain the PM from being generated and the PN from being increased.

### PRIOR ART LITERATURES

### Patent Literature

Patent Literature 1: JP H09-68071 A

### SUMMARY OF INVENTION

It is an object of the present disclosure to provide a control apparatus of an internal combustion engine that is suitable to a state of the internal combustion engine and that can restrain a particulate matter from being generated.

According to one aspect of the present disclosure, a control apparatus controls an internal combustion engine mounted in a vehicle to directly inject fuel into a cylinder. The control apparatus includes: a PM-PN exhaust determination part that determines whether or not an operation state of the internal combustion engine is a PM-PN exhaust state in which a particulate matter generated due to a fuel combustion in the cylinder is increased as compared with other operation states; and a control value calculation part that calculates a control value of an actuator to regulate at least one of a fuel injection timing, a number of injections of the fuel, a fuel injection pressure, an intake valve timing, and an exhaust valve timing of the internal combustion engine. The control value calculation part includes an in-cylinder state estimation part that estimates a state to which the cylinder belongs between a plurality of PM-PN generation states. The PM-PN generation states are states in which the particulate matter is easily generated as compared with the other state, and different from each other in a cause to generate the particulate matter. Further, in a case where the operation state of the internal combustion engine is determined to be the PM-PN exhaust state, the control value calculation part calculates the control value in such a way as to eliminate the PM-PN generation state according to the PM-PN generation state to which the state in the cylinder belongs.

In the present disclosure, in a case where the state in the cylinder of the internal combustion engine is determined to be the PM-PN exhaust state, the control value calculation part calculates the control value of the actuator to regulate the fuel injection timing or the like in such a way as to eliminate the PM-PN generation state according to the PM-PN generation state to which the state in the cylinder belongs. Hence, in the present disclosure, it is possible to restrict a generation of the PM-PN exhaust state in such a way as to be suitable to the state of the internal combustion engine.

According to the present disclosure, it is possible to provide a control apparatus of an internal combustion engine that can restrict a generation of the PM-PN exhaust state in such a way as to be suitable to the state of the internal combustion engine.

### BRIEF DESCRIPTION OF DRAWINGS

The objective described above, the other objectives, features, and advantages of the present disclosure will be made more apparent from the following detailed description with reference to the accompanying drawings.

FIG. 1 is a schematic configuration diagram of a drive system to which an ECU is applied according to an embodiment of the present disclosure.

FIG. 2 is a control block diagram for describing functional blocks of the ECU shown in FIG. 1.

FIG. 3 is a flow chart of a base routine that the ECU performs according to the embodiment of the present disclosure.

FIG. 4 is a flow chart showing a processing flow in a PM-PN exhaust determination shown in FIG. 3.

FIG. 5 is a time chart showing one example of an operation state of a vehicle and an engine.

FIG. 6 is a flow chart showing a processing flow in an in-cylinder state estimation shown in FIG. 3.

FIG. 7 is a chart showing a cold map.

FIG. 8 is a chart showing a hot map.

FIG. 9 is a flow chart showing a processing flow in an actuator control value calculation for a restrictive control of PM-PN shown in FIG. 3.

FIG. 10 is a time chart showing one example of a control performed by the ECU in a case where the operation state in a cylinder is a WET state.

FIG. 11 is a time chart showing one example of a control performed by the ECU in a case where the operation state in the cylinder is a nonuniform state.

FIG. 12 is a time chart showing one example of a control performed by the ECU in a case where the operation state in the cylinder is a high temperature state.

### EMBODIMENT FOR CARRYING OUT INVENTION

Hereinafter, an embodiment of the present disclosure will be described with reference to the accompanying drawings. In order to easily understand a description, the same constituent elements in the respective drawings will be denoted by the same reference symbols as far as possible and a duplicate description of the element will be omitted.

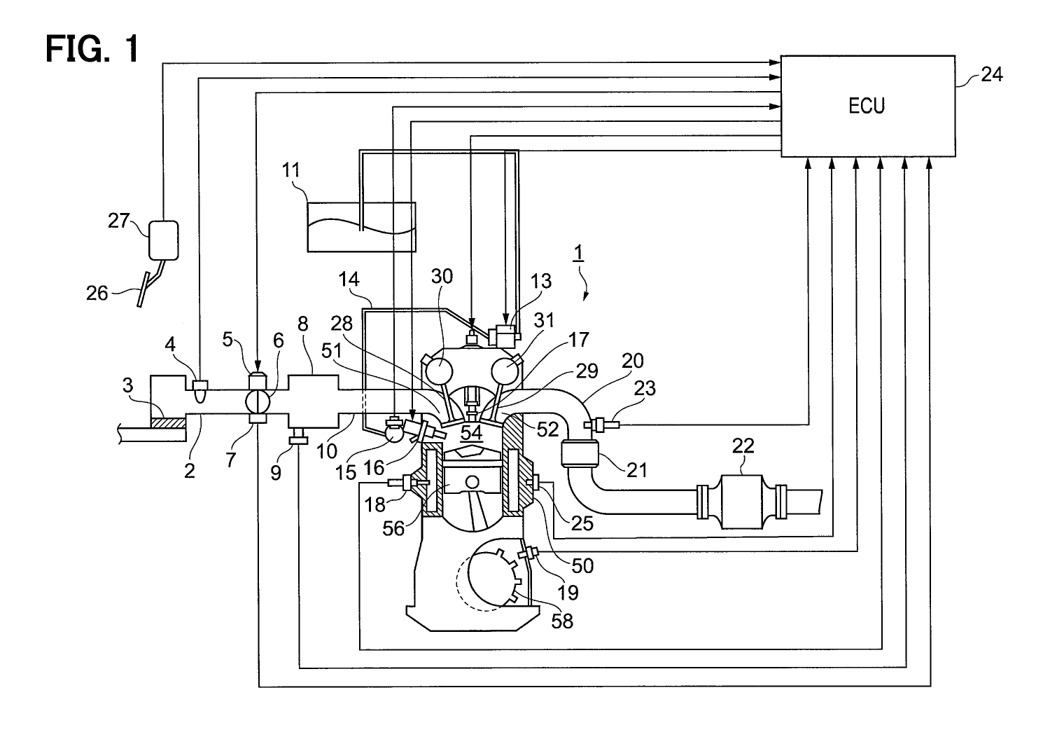

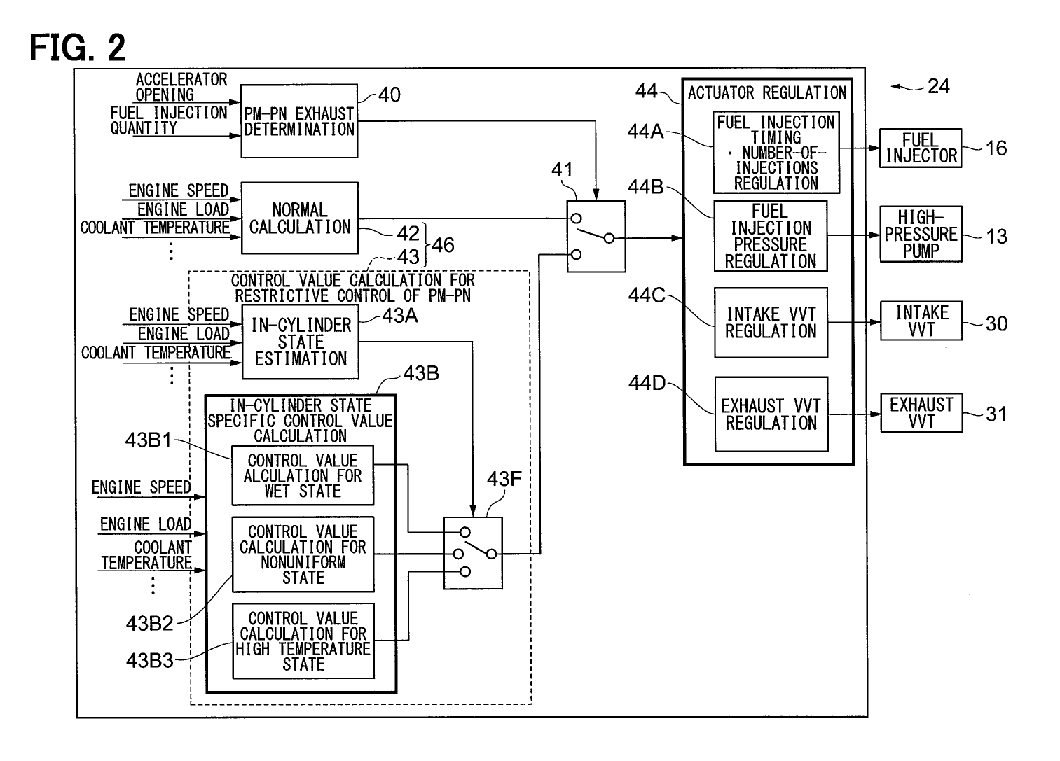

First, a general description of an ECU 24 according to an embodiment of the present disclosure will be made with reference to FIG. 1 and FIG. 2. The ECU 24 is applied to a drive system of a vehicle. The ECU 24 is mainly constructed of a microcomputer. First, a construction of an engine 1 which is an object to be controlled by the ECU 24 will be described.

The engine 1 is an internal combustion engine of a direct injection type and includes a plurality of cylinders 50. In FIG. 1, only one cylinder 50 is shown but, in reality, multiple cylinders 50 are arranged side by side. In each of the cylinders 50, a piston 56 reciprocated in a vertical direction is arranged. A combustion chamber 54 is formed between an upper inside wall surface of each cylinder 50 and the piston 56. The engine 1 is provided with an intake pipe 2, which intakes air for combustion from an outside, and an exhaust pipe 20, which guides an exhaust gas discharged from the engine 1 to the outside.

In a most upstream portion of the intake pipe 2, a filter-shaped air cleaner 3 is provided to remove a foreign matter from the air passing through the intake pipe 2. Further, on a downstream side of the air cleaner 3, an air flowmeter 4 to detect a flow rate of the intake air is provided.

On a downstream side of the flowmeter 4, a throttle valve 6 to open or close a flow channel in the intake pipe 2 is provided. The throttle valve 6 is driven by a DC motor 5 and can have its opening (throttle opening) regulated. The throttle opening is sensed by a throttle sensor 7.

On a downstream side of the throttle valve 6, a surge tank 8 is provided. The surge tank 8 is provided with an intake pressure sensor 9 to sense an intake pressure. Between the surge tank 8 and an intake port 51 of each cylinder 50, an intake manifold 10 to introduce the air into each cylinder 50 is interposed.

The engine 1 is provided with an intake valve 28 to open or close a flow channel between the intake port 51 and the combustion chamber 54. Further, the engine 1 is provided with an exhaust valve 29 to open or close a flow channel between the exhaust port 52 and the combustion chamber 54. The intake valve 28 is provided with a variable valve timing mechanism 30 to regulate a valve timing thereof. Further, the exhaust valve 29 is provided with a variable valve timing mechanism 31 to regulate a valve timing thereof.

A fuel injector 16 is provided near the intake valve 28 of each cylinder 50 of the engine 1 in such a way as to face the combustion chamber 54. The fuel injector 16 has a delivery pipe 14 connected thereto. The delivery pipe 14 is extended to a fuel tank 11 via a high-pressure pump 13. When the fuel injector 16 receives a control signal outputted from the ECU 24, the fuel injector 16 is opened to inject fuel directly to the combustion chamber 54 in each cylinder 50, the fuel being supplied from the fuel tank 11 and having its pressure regulated to a predetermined pressure by the high-pressure pump 13. A pressure of the fuel supplied to the fuel injector 16 is sensed by a fuel pressure sensor 15 provided on an upstream side of the fuel injector 16.

In an upper portion of the combustion chamber 54 of each cylinder 50, an ignition plug 17 is provided. The ignition plug 17 makes a spark discharge and ignites an air-fuel mixture of the fuel and the air.

A cylinder block of the engine 1 is provided with a knock sensor 25, a coolant temperature sensor 18, and a crank angle sensor 19. The knock sensor 25 senses a knocking of the engine 1 and outputs a signal corresponding to its sensing. Further, the coolant temperature sensor 18 senses a temperature of a coolant to cool the engine 1 and outputs a signal corresponding to its sensing. The crank angle sensor 19 senses a revolution of a crankshaft 58 at a predetermined crank angle and outputs a signal corresponding to its sensing. The ECU 24 receives the signals outputted from the knock sensor 25, the coolant temperature sensor 18, and the crank angle sensor 19 and uses the signals so as to control the engine 1. For example, the ECU 24 carries out an operation on the basis of the signal outputted from the crank angle sensor 19 to thereby sense a crank angle and an engine speed.

On the other hand, the exhaust pipe 20 of the engine 1 is provided with an upstream catalyst 21 and a downstream catalyst 22 which clean the exhaust gas generated by the combustion of the fuel in the cylinders 50. Further, on an upstream side of the upstream catalyst 21, an exhaust gas sensor 23 to sense an air-fuel ratio or the like of the exhaust gas is provided.

A driver of the vehicle presses down an accelerator pedal 26 provided in the vehicle to thereby accelerate the vehicle. A pressing-down amount of the accelerator pedal 26 (accelerator opening) is sensed by an accelerator pedal senor 27. The accelerator pedal senor 27 outputs a signal corresponding to the sensed accelerator opening. The ECU 24 receiving the signal makes the fuel injector 16 inject the fuel of a quantity corresponding to the accelerator opening to increase the fuel to be combusted in the combustion chamber 54 in the cylinder 50, thereby bringing the vehicle into an acceleration state.

The ECU 24 receives the signals outputted from the various kinds of sensors as described above and performs various kinds of control routines stored in a ROM (storage medium) built therein. In this way, the ECU 24 controls a quantity of the fuel injected by the fuel injector 16, a fuel injection timing, a fuel pressure by a high-pressure pump 13, an opening/closing timing of the intake valve 28 and the exhaust valve 29, and an ignition timing by the ignition plug 17 according to an operation state of the engine 1.

FIG. 2 shows the ECU 24 as a functional control block diagram. The ECU 24 includes a PM-PN exhaust determination part 40, a control value calculation part 46, and an actuator regulation part 44.

The PM-PN exhaust determination part 40 is a part to determine whether or not the operation state of the engine 1 is in a PM-PN exhaust state in which a particulate matter generated due to a fuel combustion in the cylinder is increased as compared with other operation state. Specifically, the PM-PN exhaust determination part 40 reads an accelerator opening, which is sensed by the accelerator pedal sensor 27, and a fuel injection quantity, which is calculated from a sensed value of the fuel pressure sensor 15, and determines whether or not the vehicle is in the acceleration state from these read values. This is because of the following reason: there is a strong correlation between the acceleration state of the vehicle and the discharged particulate matter, so that when the vehicle is brought into the acceleration state, it can be determined that the operation state of the engine 1 is brought into the PM-PN exhaust state.

In this regard, in the present embodiment, it is determined on the basis of the acceleration opening and the fuel injection quantity whether or not the vehicle is in the acceleration state, but the present disclosure is not limited to this. In other words, whether or not the vehicle is in the acceleration state can also be determined by the use of other index correlated to the acceleration state of the vehicle, such as a throttle opening, an intake air quantity, the number of revolutions and a load of the engine 1, and a vehicle speed.

The control value calculation part 46 includes a control value calculation part 42 for a normal control (hereinafter referred to as “a normal calculation part 42”) and a control value calculation part 43 for a restrictive control of PM-PN (hereinafter referred to as “a restrictive calculation part 43”). The normal calculation part 42 is a part to calculate a control value for controlling each of actuators of the fuel injector 16, the high-pressure pump 13, and the variable valve timing mechanisms 30, 31 in a case where a PM-PN exhaust, which will be described later in detail, is not especially restricted. On the other hand, the restrictive calculation part 43 is a part to calculate a control value for controlling each of the actuators described above in a case where the PM-PN exhaust is restricted.

The restrictive calculation part 43 includes an in-cylinder state estimation part 43A, an in-cylinder state specific control value calculation part 43B, and a selection part 43F.

The in-cylinder state estimation part 43A is a part to estimate a state in the cylinder 50 of the engine 1. Describing in more detail, the in-cylinder state estimation part 43A reads the number of revolutions of the engine 1, the load of the engine 1, and the coolant temperature of the engine 1 and estimates which state of three PM-PN generation states of “a WET state”, “a nonuniform state”, and “a high temperature state”, the state in the cylinder 50 belongs to.

These three PM-PN generation states are states in which the particulate matter is easily generated as compared with other states and are classified on the basis of a generation factor of the particulate matter. “The WET state” is a state in which the fuel easily exists in a liquid state in the cylinder 50 as compared with “the nonuniform state”, and “the high temperature state” and in which it is concerned that the particulate matter is generated due to this. Further, “the nonuniform state” is a state in which a concentration of the fuel easily becomes nonuniform in the cylinder 50 as compared with “the WET state” and “the high temperature state” and in which it is concerned that the particulate matter is generated due to this. Still further, “the high temperature state” is a state in which a temperature in the cylinder 50 easily becomes high as compared with “the WET state” and “the nonuniform state” and in which it is concerned that the particulate matter is generated due to this.

In this regard, in the present embodiment, the state in the cylinder 50 is estimated on the basis of the number of revolutions, the load, and the coolant temperature of the engine 1, but the present disclosure is not limited to this. In other words, the above-mentioned estimation can also be made by the use of other index correlated with the state in the cylinder 50 such as the throttle opening, the accelerator opening, the vehicle speed, the fuel injection quantity, and the intake air quantity.

Further, the in-cylinder state specific control value calculation part 43B includes a control value calculation part 43B1 for a WET state, a control value calculation part 43B2 for a nonuniform state, and a control value calculation part 43B3 for a high temperature state. The control value calculation part 43B1 for a WET state is a part to calculate a control value for controlling each of the actuators of the fuel injector 16, the high-pressure pump 13, and the variable valve timing mechanisms 30, 31 in a case where it is estimated that the state in the cylinder 50 is the WET state. Similarly, the control value calculation part 43B2 for a nonuniform state calculates a control value for controlling each of the actuators in a case where it is estimated that the state in the cylinder 50 is the nonuniform state. Further, the control value calculation part 43B3 for a high temperature state calculates a control value for controlling each of the actuators in a case where it is estimated that the state in the cylinder 50 is the high temperature state.

The selection part 43F selects one of the control values calculated by the control value calculation part 43B1 for a WET state, the control value calculation part 43B2 for a nonuniform state, and the control value calculation part 43B3 for a high temperature state on the basis of an estimation result in the in-cylinder state estimation part 43A.

The ECU 24 further includes a selection part 41. The selection part 41 selects the control value calculated by one of the normal calculation part 42 and the restrictive calculation part 43 on the basis of a determination result in the PM-PN exhaust determination part 40. In other words, in a case where it is determined that the operation state of the engine 1 is not the PM-PN exhaust state, the selection part 41 selects the control value calculated by the normal calculation part 42. On the other hand, in a case where it is determined that the operation state of the engine 1 is the PM-PN exhaust state, the selection part 41 selects the control value calculated by the restrictive calculation part 42.

The actuator regulation part 44 regulates each of the actuators on the basis of the control value calculated by the control value calculation part 46. The actuator regulation part 44 includes a fuel injection timing •number-of-injections regulation part 44A, a fuel injection pressure regulation part 44B, a variable valve timing regulation part 44C for intake, and a variable valve timing regulation part 44D for exhaust. The fuel injection timing •number-of-injections regulation part 44A regulates the fuel injector 16 in such a way that the fuel injection timing and the number of injections are brought into the control values selected by the selection part 41. Further, the fuel injection pressure regulation part 44B regulates the high-pressure pump 13 in such a way that the fuel injection pressure is brought into the control value selected by the selection part 41. Still further, the variable valve timing regulation part 44C for intake regulates the variable valve timing regulation mechanism 30 in such a way that the valve timing of the intake valve 28 is brought into the control value selected by the selection part 41. Still further, the variable valve timing regulation part 44D for exhaust regulates the variable valve timing regulation mechanism 31 in such a way that the valve timing of the exhaust valve 29 is brought into the control value selected by the selection part 41.

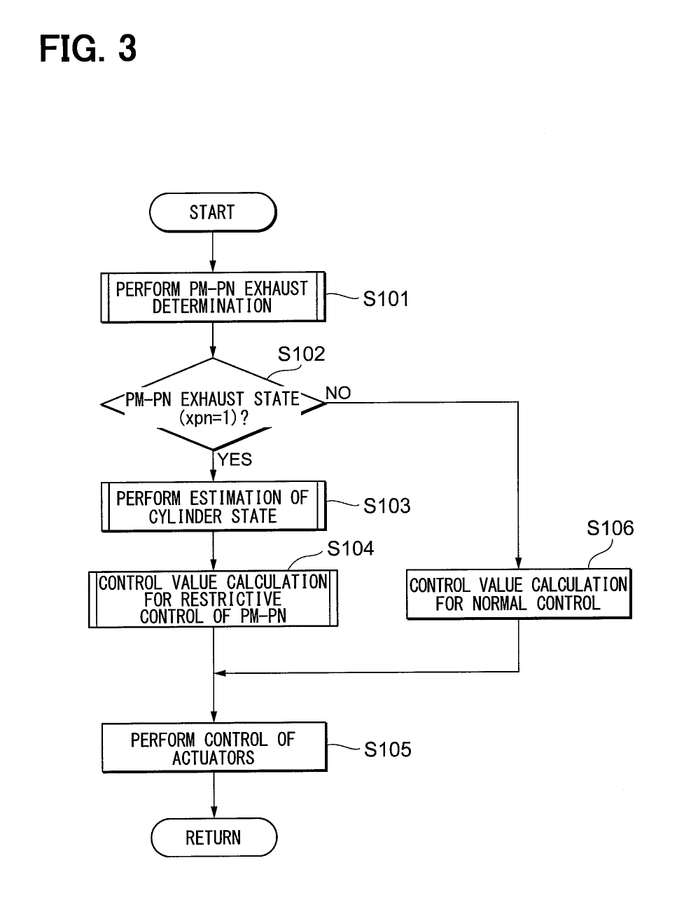

Next, a control of the engine 1 by the ECU 24 will be described with reference to FIG. 3 to FIG. 13. In this regard, in the following description, for simplicity, it will be described that also processing which is performed, when described in detail, by the PM-PN exhaust determination part 40 and the like of the ECU 24 is performed by the ECU 24.

The ECU 24 performs the processing according to a base routine shown in FIG. 3. When an ignition switch of the vehicle is turned on, the ECU 24 performs initializing processing before performing the base routine. In the initializing processing, the ECU 24 sets “0” to a PM-PN exhaust state flag “xpn”, which will be described later, and to a calculated value.

First, in step S101, the ECU 24 determines on the basis of values of the accelerator opening and the fuel injection quantity whether or not the operation state of the engine 1 is the PM-PN exhaust state.

### [PM-PN Exhaust Determination]

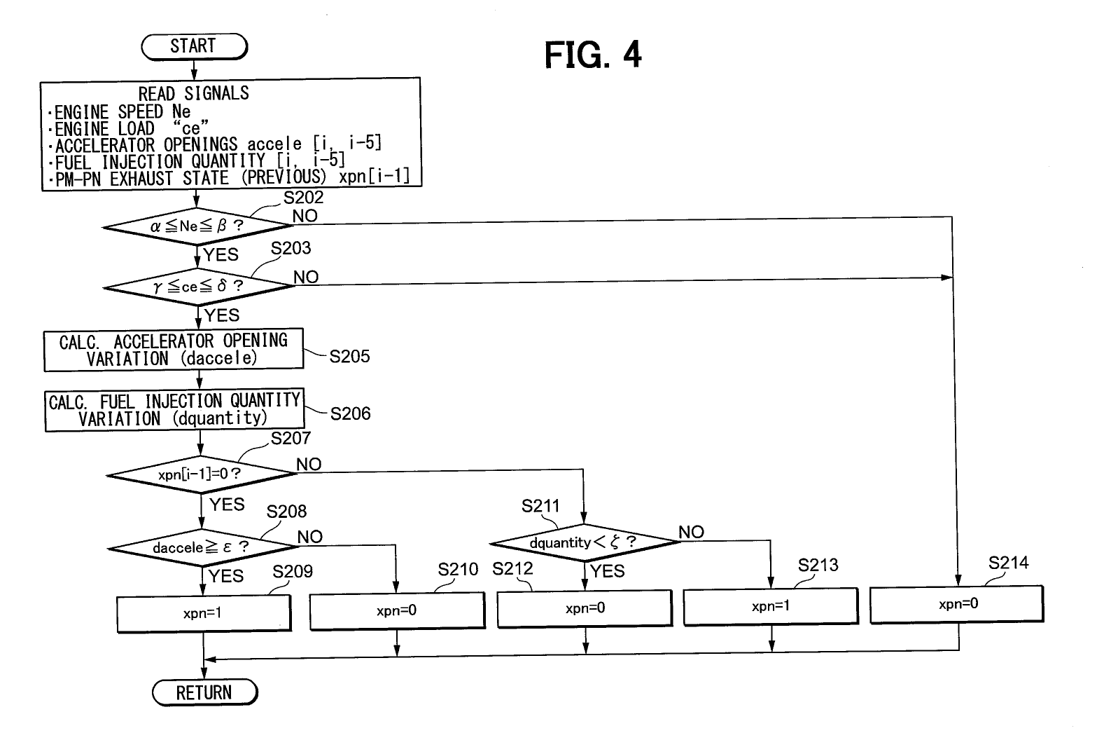

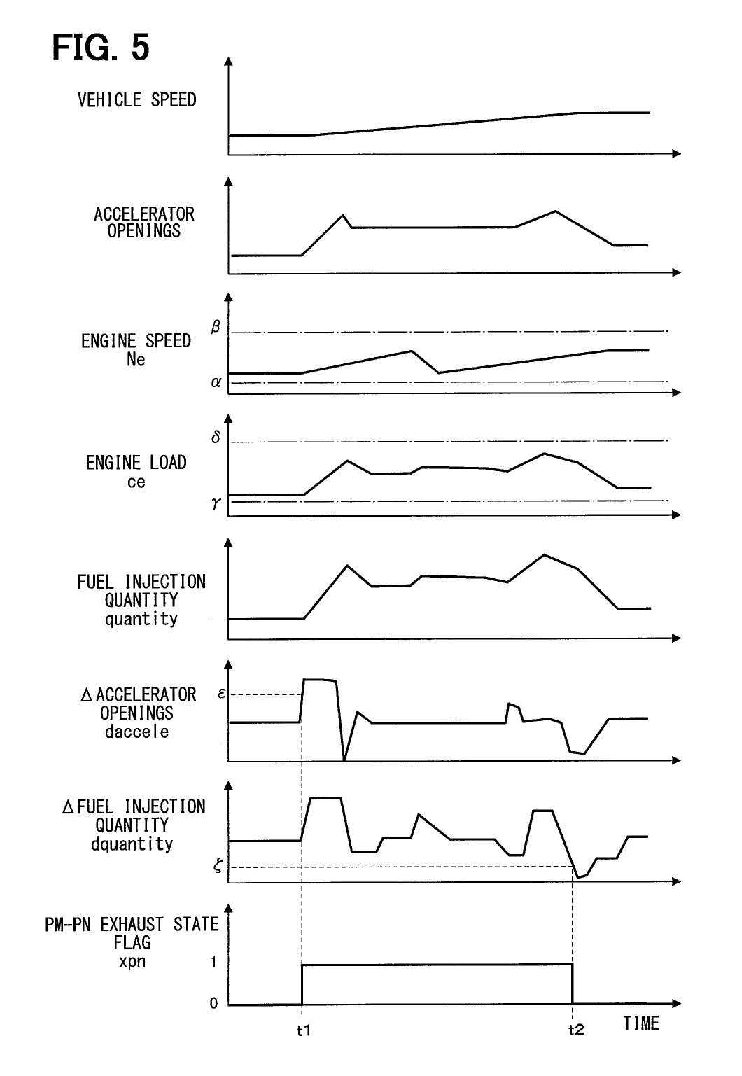

A determination whether or not the operation state of the engine 1 is the PM-PN exhaust state will be described with reference to FIG. 4 and FIG. 5. FIG. 4 shows a subroutine for a determination in step S101 of the base routine. The ECU 24 repeatedly performs the present subroutine at a specified period (for example, at a period of 10 ms). Further, FIG. 5 shows operation states of the vehicle and the engine 1 and here shows an example in a case where the vehicle traveling at a constant speed accelerates on the way and then again travels at a constant speed.

First, the ECU 24 reads the engine speed Ne, an engine load “ce”, accelerator openings accele [i, i−5] of this period and five periods ago, fuel injection quantities [i, i−5] of this period and five periods ago, and a PM-PN exhaust state flag xpn[i−1] of one period ago of the engine 1. In the following description, the number of revolutions Ne and the load “ce” of the engine 1 will be referred to as “an engine speed Ne” and “an engine load ce”, respectively.

Next, in step S202, the ECU 24 determines whether or not the engine speed Ne is within a predetermined range (α≦Ne≦β). In a case where the engine speed Ne is within the predetermined range (S202: YES), the ECU 24 proceeds to step S203.

Next, in step S203, the ECU 24 determines whether or not the engine load “ce” is within a predetermined range (γ≦ce≦δ). In a case where the engine load “ce” is within the predetermined range (S203: YES), the ECU 24 proceeds to step S205.

Next, in step S205, the ECU 24 calculates an accelerator opening variation daccele from 5 periods ago to the present period. After the ECU 24 calculates the accelerator opening variation daccele, the ECU 24 proceeds to step S206.

Next, in step S206, the ECU 24 calculates a fuel injection quantity variation dquantity from 5 periods ago to the present period. After the ECU 24 calculates the fuel injection quantity variation dquantity, the ECU 24 proceeds to step S207.

Next, in step S207, the ECU 24 determines whether or not “0” is set to the PM-PN exhaust state flag xpn[i−1] of one period ago. Here, in a case where “0” is set to the PM-PN exhaust state flag “xpn” of one period ago, it is shown that the engine 1 is not in the PM-PN exhaust state. On the other hand, in a case where “1” is set to the PM-PN exhaust state flag “xpn” of one period ago, it is shown that the engine 1 is in the PM-PN exhaust state. In a case where “0” is set to the PM-PN exhaust state flag xpn[i−1] of one period ago and where it is hence determined that the engine 1 is not in the PM-PN exhaust state, the ECU 24 proceeds to step S208.

Next, in step S208, the ECU 24 determines whether or not the accelerator opening variation daccele is a threshold value ε or more. In a case where a driver of the vehicle presses down the accelerator pedal 26 so as to accelerate the vehicle and where, as shown at a time t1 of FIG. 5, the accelerator opening variation daccele is the threshold value ε or more (S208: YES), the ECU 24 proceeds to step S209.

Next, in step S209, the ECU 24 sets “1” to the PM-PN exhaust state flag “xpn”. By a fact that the accelerator opening variation daccele is the threshold values or more, it can be determined that the vehicle starts an accelerating state and hence it can be predicted that a particulate matter to be discharged will be increased. Hence, “1”, which shows that the operation state of the engine 1 is the PM-PN exhaust state, is set to the PM-PN exhaust state flag “xpn”.

In this way, it is determined on the basis of the accelerator opening variation daccele that the vehicle starts the acceleration state, so that it is possible to quickly detect that the vehicle is brought into the acceleration state and to reflect that the vehicle is brought into the acceleration state to the processing. There is caused a time lag from a time when the driver of the vehicle presses down the accelerator pedal 26 to a time when each of the actuators such as the high-pressure pump 13 starts to operate in response to this. By determining that the vehicle starts the acceleration state on the basis of the accelerator opening variation daccele, it is possible to eliminate the time lag and to quickly detect that the vehicle is brought into the acceleration state.

On the other hand, in a case where it is determined in step S208 that the accelerator opening variation daccele is not the threshold value ε or more (S208: NO), the ECU 24 proceeds to step S210.

Next, in step S210, the ECU 24 sets “0” to the PM-PN exhaust state flag “xpn”. The accelerator opening variation daccele is not the threshold value ε or more, so that it can be determined that the vehicle does not start the acceleration state and it can be predicted that the discharged particulate matter is not increased so much. Hence, the ECU 24 sets “0”, which shows the operation state of the engine 1 is not the PM-PN exhaust state, to the PM-PN exhaust state flag “xpn”.

In contrast to this, in a case where “0” is not set to the PM-PN exhaust state flag xpn[i−1] of one period ago in step S207 (S207: NO), the ECU 24 proceeds to step S211. In this case, “1” is set to the PM-PN exhaust state flag xpn[i−1] of one period ago and the operation state of the engine 1 is the PM-PN exhaust state. In other words, the vehicle is in the acceleration state.

Next, in step S211, the ECU 24 determines whether or not the fuel injection quantity variation dquantity is less than a threshold value ζ. In a case where the driver of the vehicle returns the accelerator pedal 26 so as to finish the acceleration state and where, as shown at a time t2 in FIG. 5, the fuel injection quantity variation dquantity becomes less than the threshold value ζ (S211: YES), the ECU 24 proceeds to step S212.

Next, in step S212, the ECU 24 sets “0” to the PM-PN exhaust state flag “xpn”. By a fact that the fuel injection quantity variation dquantity becomes less than the threshold value ζ, it can be determined that the vehicle finishes the acceleration state. Hence, the ECU 24 sets “0”, which shows that the operation state of the engine 1 is not the PM-PN exhaust state, to the PM-PN exhaust state flag “xpn”.

In this way, by determining that the acceleration state of the vehicle is finished on the basis of the fuel injection quantity variation dquantity, it is possible to correctly detect that the acceleration state of the vehicle is finished and to reflect that the acceleration state of the vehicle is finished to the processing. There is caused a time lag from a time when the driver of the vehicle returns the accelerator pedal 26 to a time when a quantity of the fuel injected from the fuel injector 16 is changed in response to this. By determining that the vehicle finishes the acceleration state on the basis of the fuel injection quantity variation dquantity, it is possible to correctly detect a timing when the quantity of the fuel injected from the fuel injector 16 is actually changed and when the vehicle finishes the acceleration state.

On the other hand, in a case where it is determined in step S211 that the fuel injection quantity variation dquantity is not less than the threshold value ζ (S211: NO), the ECU 24 proceeds to step S213.

Next, in step S213, the ECU 24 sets “1” to the PM-PN exhaust state flag “xpn”. By a fact that the fuel injection quantity variation dquantity is not less than the threshold value C, it can be determined that the vehicle continues the acceleration state. Hence, the ECU 24 sets “1”, which shows the operation state of the engine 1 is the PM-PN exhaust state, to the PM-PN exhaust state flag “xpn”.

Here, in a case where it is determined in step S202 that the engine speed Ne is not within the predetermined range (α≦Ne≦β) (S202: NO) or in a case where it is determined in step S203 that the engine load “ce” is not within the predetermined range (γ≦ce≦δ) (S203: NO), the ECU 24 proceeds to step S214.

Next, in step S214, the ECU 24 sets “0” to the PM-PN exhaust state flag “xpn”. When processing for restricting the PM-PN exhaust, which will be described later, is performed even in a case where the engine speed Ne and the engine load “ce” are not within the predetermined ranges respectively set for them, a significant decrease in the output of the engine 1 is likely to be caused. In order to avoid this problem, in a case where the engine speed Ne and the engine load “ce” are not within the predetermined ranges respectively set for them, the ECU 24 sets “0” to the PM-PN exhaust state flag “xpn” and does not perform the processing for restricting the PM-PN exhaust.

Returning to FIG. 3, the description will be continuously made. The ECU 24 having finished the processing of step S101 determines in step S102 whether or not the operation state of the engine 1 is the PM-PN exhaust state. Specifically, the ECU 24 determines whether or not the “1” is set to the PM-PN exhaust state flag “xpn”. In a case where the operation state of the engine 1 is the PM-PN exhaust state, the ECU 24 proceeds to step S103.

### [In-Cylinder State Estimation]

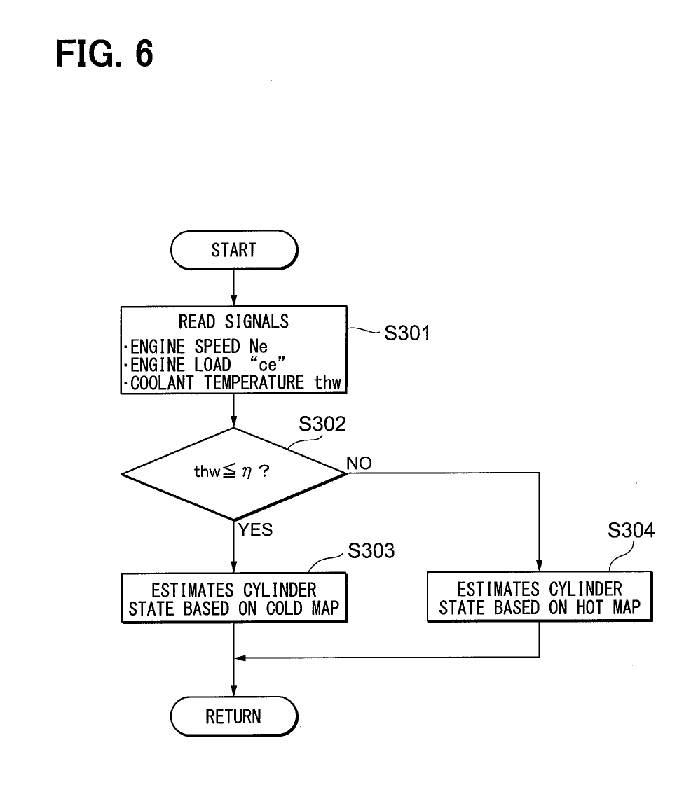

Next, in step S103, the ECU 24 makes an estimation of a state in the cylinder 50. The estimation is made so as to perform a restrictive control of the PM-PN suitable for the state in the cylinder 50 in a later step. The estimation will be described in detail with reference to FIG. 6 to FIG. 8. FIG. 6 shows a subroutine for an in-cylinder state estimation in step S103 of the base routine. The ECU 24 repeatedly performs the present subroutine at a predetermined period (for example, at a period of 10 ms).

First, in step S301 of FIG. 6, the ECU 24 reads the engine speed Ne, the engine load “ce”, and a coolant temperature “thw” of the engine 1. In the following description, the coolant temperature “thw” of the engine 1 is referred to as “an engine coolant temperature “thw”.

Next, in step S302, the ECU 24 determines whether or not the engine coolant temperature “thw” is a threshold value η or less. In a case where the engine coolant temperature “thw” is the threshold value η or less (S302: YES), the ECU 24 proceeds to step S303.

Next, in step S303, the ECU 24 estimates the state in the cylinder 50 on the basis of a cold map.

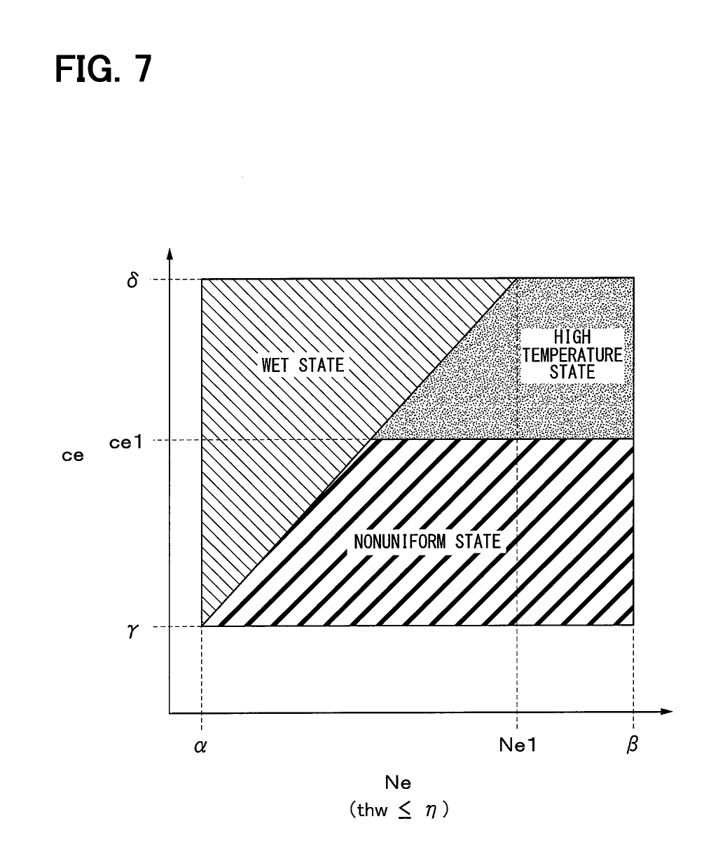

The cold map is a map stored in a ROM built in the ECU 24 and, as shown in FIG. 7, has the engine speed Ne and the engine load “ce” as coordinates axes. In the cold map, a range where the engine speed Ne is α≦Ne≦β and where the engine load “ce” is γ≦ce≦δ is divided into three sections. The PM-PN generation states of “the WET state”, “the nonuniform state”, and “the high temperature state” are specified in the respective sections. As described above, these three PM-PN generation states are states different from each other in a cause of generating the particulate matter.

In a case where the engine coolant temperature “thw” is the threshold value η or less, the ECU 24 compares the engine speed Ne and the engine load “ce”, which have been read in step S301, with the cold map, thereby estimating the state in the cylinder 50. Specifically, the ECU 24 specifies which of “the WET state”, “the nonuniform state”, and “the high temperature state”, a combination of the engine speed Ne and the engine load “ce” belongs to.

On the other hand, in a case where it is determined in step S302 that the engine coolant temperature “thw” is not the threshold value η or less, the ECU 24 proceeds to step S304.

Next, in step S304, the ECU 24 estimates the state in the cylinder 50 on the basis of a hot map.

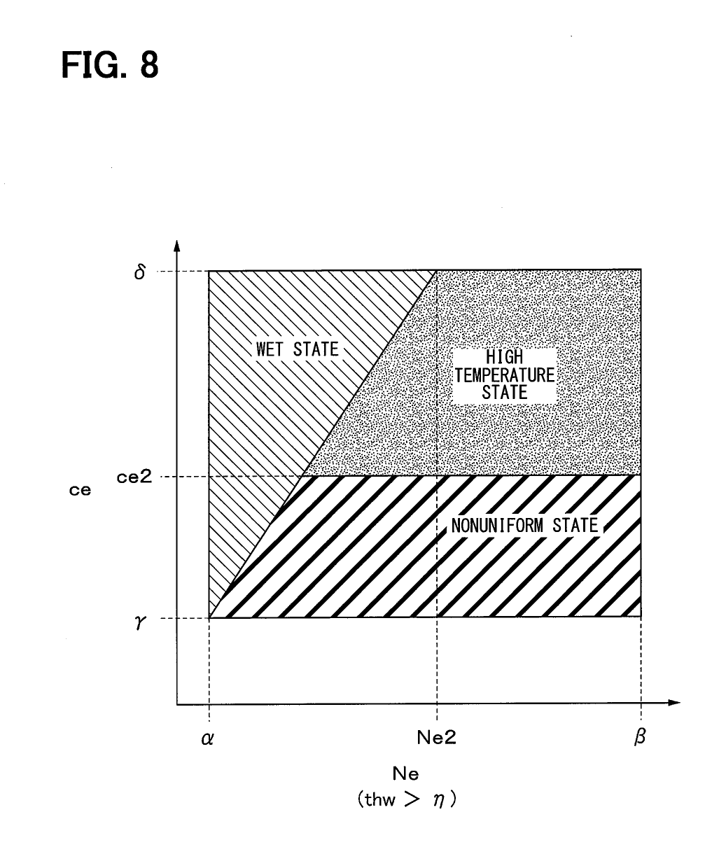

The hot map, similarly to the cold map, is a map stored in the ROM built in the ECU 24 and, as shown in FIG. 8, has the engine speed Ne and the engine load “ce” as the coordinates axes. In the hot map, the range where the engine speed Ne is α≦Ne≦β and where the engine load “ce” is γ≦ce≦δ is also divided into three PM-PN generation states of “the WET state”, “the nonuniform state”, and “the high temperature state”, which is similar to the cold map.

The hot map is different from the cold map in a range where each of “the WET state”, “the nonuniform state”, and “the high temperature state” occupies. Specifically, in the cold map, a range where the engine speed Ne is α≦Ne≦Ne1 is specified to be “the WET state”, whereas in the hot map, a range where the engine speed Ne is α≦Ne≦Ne2, which is narrower than the cold map, is specified to be “the WET state”. This is because of the following reason: in a state where the engine coolant temperature “thw” is high and where the temperature in the cylinder 50 is also high, it is little concerned that the fuel exists in a liquid state, so that a range of “the WET state” is also specified to be narrow.

Further, in the cold map, a range where the engine load “ce” is ce1≦ce≦δ is specified to be “the hot temperature state”, whereas in the hot map, a range where the load “ce” is ce2≦ce≦δ, which is wider than the cold map, is specified to be “the hot temperature state”. This is because of the following reason: in a state where the engine coolant temperature “thw” is high, it is concerned that the temperature in the cylinder 50 is increased excessively, so that a range of “the hot temperature state” is also specified to be wide.

In a case where the engine coolant temperature “thw” is not the threshold value η or less, the ECU 24 compares the engine speed Ne and the engine load “ce”, which have been read in S301, with the hot map, thereby estimating the state in the cylinder 50. Specifically, the ECU 24 specifies which of “the WET state”, “the nonuniform state”, and “the high temperature state”, a combination of the engine speed Ne and the engine load “ce” belongs to.

Here, in the present embodiment, the ECU 24 estimates the state in the cylinder 50 on the basis of the engine speed Ne, the engine load “ce”, and the engine coolant temperature “thw”, but the present disclosure is not limited to these. In other words, the ECU 24 may estimate the state in the cylinder 50 on the basis of at least one of the engine coolant temperature “thw”, the engine speed Ne, the engine load “ce”, the intake air quantity, the throttle opening, the accelerator opening, the vehicle speed, the fuel injection quantity, and other temperature in the engine 1.

Returning to FIG. 3, the description will be continuously made. The ECU 24 having finished the processing of step S103 proceeds to step S104.

### [Actuator Control Value Calculation for an Restrictive Control of PM-PN]

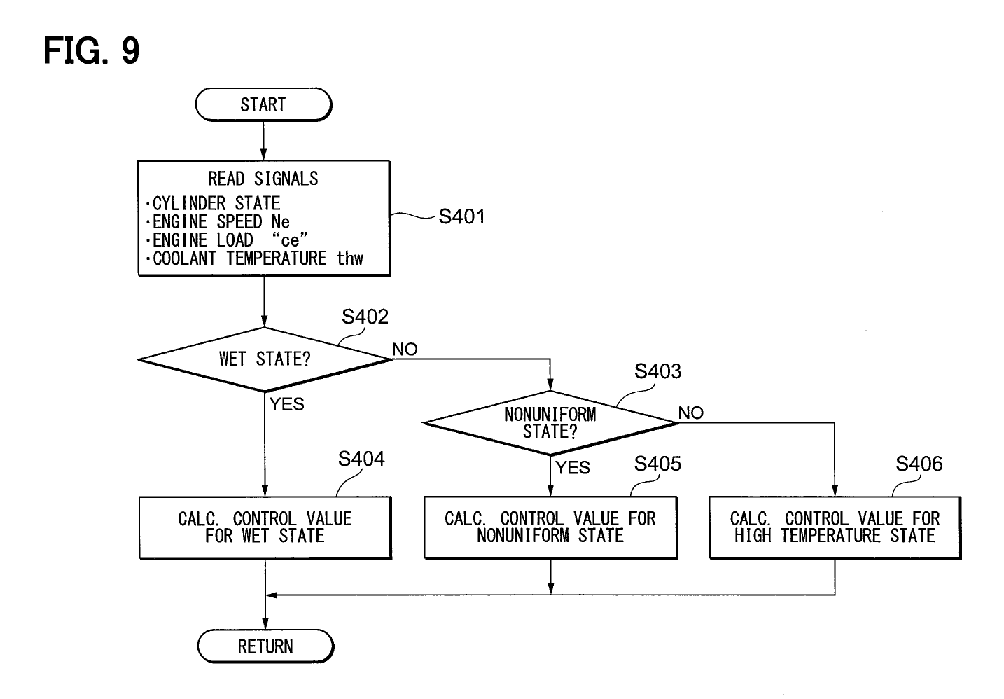

Next, in step S104, the ECU 24 calculates an actuator control value for a restrictive control of PM-PN. A calculation of the control value will be described with reference to FIG. 9. FIG. 9 shows a subroutine for calculating a control value for a restrictive control of PM-PN in step S104 of the base routine.

First, in step S401 of FIG. 9, the ECU 24 reads the state estimated by estimating the state in the cylinder 50, the engine speed Ne, the engine load “ce”, and the engine coolant temperature “thw”. After the ECU 24 reads these values, the ECU 24 proceeds to step S402.

Next, in step S402, the ECU 24 determines whether or not the state in the cylinder 50 is “the WET state”. In a case where it is determined that the state in the cylinder 50 is “the WET state” (S402: YES), the ECU 24 proceeds to step S404.

Next, in step S404, the ECU 24 calculates the control value of each actuator on the basis of a control value map corresponding to “the WET state”. In the present embodiment, the control value map which has the engine speed Ne and the engine load “ce” as coordinate axes and which is used for calculating a fuel injection timing, a fuel injection pressure, an intake valve timing, and an exhaust valve timing, which are suitable for eliminating “the WET state”, is stored in the ROM of the ECU 24. The ECU 24 calculates control values for controlling the respective actuators of the fuel injector 16, the high-pressure pump 13, and the variable valve timing mechanisms 30, 31 on the basis of the control value map corresponding to “the WET state”.

On the other hand, in a case where it is determined in step S402 that the state in the cylinder 50 is not “the WET state” (S402: NO), the ECU 24 proceeds to step S403.

Next, in step S403, the ECU 24 determines whether or not the state in the cylinder 50 is “the nonuniform state”. In a case where the state in the cylinder 50 is “the nonuniform state” (S403: YES), the ECU 24 proceeds to step S405.

Next, in step S405, the ECU 24 calculates the control value of each actuator on the basis of a control value map corresponding to “the nonuniform state”. In the present embodiment, a control value map which has the engine speed Ne and the engine load “ce” as the coordinate axes and which is used for calculating a fuel injection timing, a fuel injection pressure, an intake valve timing, and an exhaust valve timing, which are suitable for eliminating “the nonuniform state”, is stored in the ROM of the ECU 24. The ECU 24 calculates control values for controlling the respective actuators of the fuel injector 16, the high-pressure pump 13, and the variable valve timing mechanisms 30, 31 on the basis of the control value map corresponding to “the nonuniform state”.

On the other hand, in a case where it is determined in step S403 that the state in the cylinder 50 is not “the WET state” (S403: NO), that is, in a case where the state in the cylinder 50 is “the high temperature state”, the ECU 24 proceeds to step S406.

Next, in step S406, the ECU 24 calculates the control value of each actuator on the basis of a control value map corresponding to “the high temperature state”. In the present embodiment, a control value map which has the engine speed Ne and the engine load “ce” as the coordinate axes and which is used for calculating a fuel injection timing, a fuel injection pressure, an intake valve timing, and an exhaust valve timing, which are suitable for eliminating “the high temperature state”, is stored in the ROM of the ECU 24. The ECU 24 calculates control values for controlling the respective actuators of the fuel injector 16, the high-pressure pump 13, and the variable valve timing mechanisms 30, 31 on the basis of the control value map corresponding to “the high temperature state”.

Returning to FIG. 3, the description will be continuously made. The ECU 24 having finished the processing of step S104 proceeds to step S105.

Next, in step S105, the ECU 24 controls the respective actuators of the fuel injector 16, the high-pressure pump 13, and the variable valve timing mechanisms 30, 31 in such a way that the respective actuators are brought into the control values calculated in step S104.

On the other hand, in a case where it is determined in step S102 that the operation state of the engine 1 is not the PM-PN exhaust state (S102: NO), the ECU 24 proceeds to step S106.

Next, in step S106, the ECU 24 calculates an actuator control value for the normal control. The actuator control value is used for controlling each of the actuators of the fuel injector 16, the high-pressure pump 13, and the variable valve timing mechanisms 30, 31 in a case where the PM-PN exhaust is not especially restricted. The ECU 24 having finished the processing of step S106 proceeds to step S105 and controls the respective actuators.

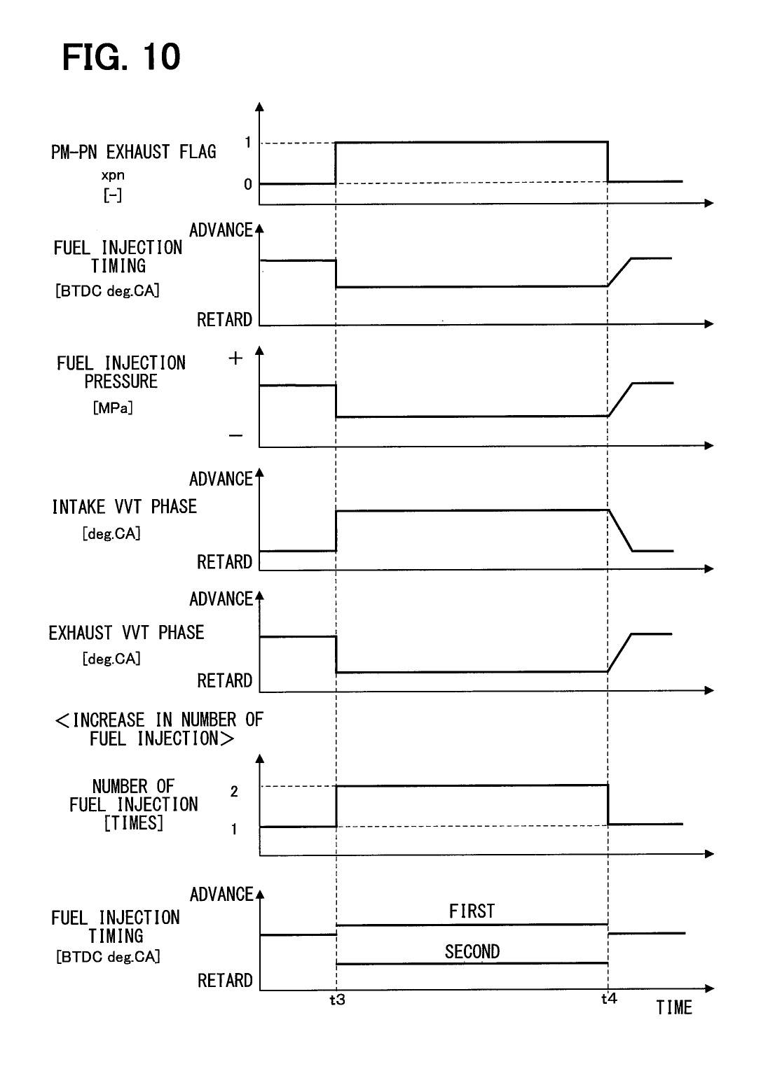

Next, an example of processing performed by the ECU 24 will be described with reference to FIG. 10 to FIG. 12. First, the processing in a case where it is estimated that the state in the cylinder 50 is “the WET state” will be described with reference to FIG. 10.

[Case where the State in the Cylinder is Estimated to be “the WET State”]

In this case, when the operation state of the engine 1 is brought into the PM-PN exhaust state at a time t3 and “1” is set to the PM-PN exhaust flag “xpn”, the ECU 24 changes the fuel injection timing to a retard side. In this way, a distance between the fuel injector 16 and the piston 56 at the time of a fuel injection is made large, which can restrict the injected fuel being attached to the piston 56 as it is liquid.

Further, the ECU 24 controls the high-pressure pump 13 in such a way that the fuel injection pressure is reduced. In this way, it is possible to restrict a flowing of the fuel injected from the fuel injector 16 through the combustion chamber 54 of the cylinder 50 and an adhesion of the fuel to the piston 56 as it is liquid.

Still further, the ECU 24 performs an internal exhaust gas recirculation (EGR) in which the high-temperature exhaust gas discharged from the cylinder 50 is made to flow into the intake port 51 in an exhaust stroke of the engine 1 and in which the high-temperature exhaust gas is made to return into the cylinder 50 in an intake stroke of the engine 1. Specifically, the ECU 24 regulates the variable valve timing mechanisms 30, 31 in such a way that the valve timing of the intake valve 28 is changed to an advance side and that the valve timing of the exhaust valve 29 is changed to a retard side. In this way, the temperature in the cylinder 50 can be increased, which can hence restrict an existence of the fuel in the cylinder 50 as it is liquid.

Still further, the ECU 24 increases the number of injections of the fuel in one intake stroke, thereby also being able to eliminate “the WET state”. In this case, the ECU 24 increases the number of injections of the fuel, which is one in one intake stroke until then, to two after the operation of the engine 1 is brought into the PM-PN exhaust state. In other words, the quantity of the fuel injected per one injection can be reduced, which hence can further restrict an existence of the fuel in the cylinder 50 as it is liquid.

Still further, in a case where the ECU 24 increases the number of injections of the fuel in one intake stroke to two, the ECU 24 changes the injection timing of a first injection to a little advance side whereas the ECU 24 changes the injection timing of a second injection greatly to a retard side. In this way, it is possible to restrict the adhesion of the fuel injected from the fuel injector 16 to the piston 56 as it is liquid.

When the operation state of the engine 1 ceases to be the PM-PN exhaust state at a time t4 and “0” is set to the PM-PN exhaust flag “xpn”, the ECU 24 returns the control values of the respective actuators to those of the normal control.

[Case where the State in the Cylinder is Estimated to be “the Nonuniform State”]

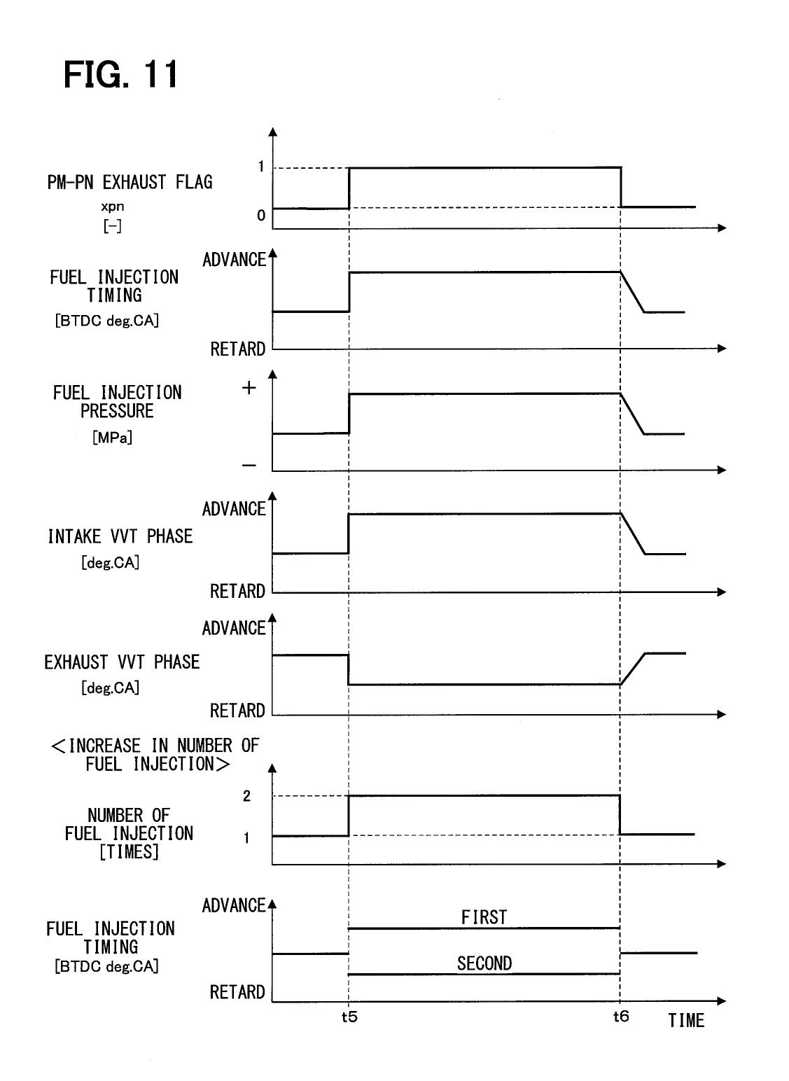

Next, processing in a case where the state in the cylinder 50 is estimated to be “the nonuniform state” will be described with reference to FIG. 11. In this case, when the operation state of the engine 1 is brought into the PM-PN exhaust state at a time t5 and “1” is set to the PM-PN exhaust flag “xpn”, the ECU 24 changes the fuel injection timing to an advance side. In this way, it is possible to secure a period of time in which the fuel is sufficiently atomized and in which the fuel and the air can be sufficiently mixed with each other between the injection of the fuel and the ignition of the fuel. Hence, it is possible to restrict the nonuniform of the fuel in the cylinder 50.

Further, the ECU 24 controls the high-pressure pump 13 in such a way that the fuel injection pressure is increased. In this way, the fuel injected at a high pressure from the fuel injector 16 can be reduced in a particle diameter and hence can be easily atomized. Hence, it is possible to restrict the nonuniform concentration of the fuel in the cylinder 50.

Still further, as is the case where the state in the cylinder 50 is estimated to be “the WET state”, the ECU 24 makes the engine 1 perform the internal EGR. Specifically, the ECU 24 regulates the variable valve timing mechanisms 30, 31 in such a way that the valve timing of the intake valve 28 is changed to the advance side and that the valve timing of the exhaust valve 29 is changed to the retard side. In this way, the temperature in the cylinder 50 can be increased to thereby accelerate the atomization of the fuel, which can hence restrict the nonuniform of the fuel in the cylinder 50.

Still further, as is the case where the state in the cylinder 50 is estimated to be “the WET state”, the ECU 24 increases the number of injections of the fuel, which is one in one intake stroke until then, to two after the operation of the engine 1 is brought into the PM-PN exhaust state. In this way, the diffusion of the fuel injected from the fuel injector 16 can be advanced, which hence can restrict the nonuniform concentration of the fuel in the cylinder 50.

When the operation state of the engine 1 ceases to be the PM-PN exhaust state at a time t6 and “0” is set to the PM-PN exhaust flag “xpn”, the ECU 24 returns the control values of the respective actuators to those of the normal control.

[Case where the State in the Cylinder is Estimated to be “the High Temperature State”]

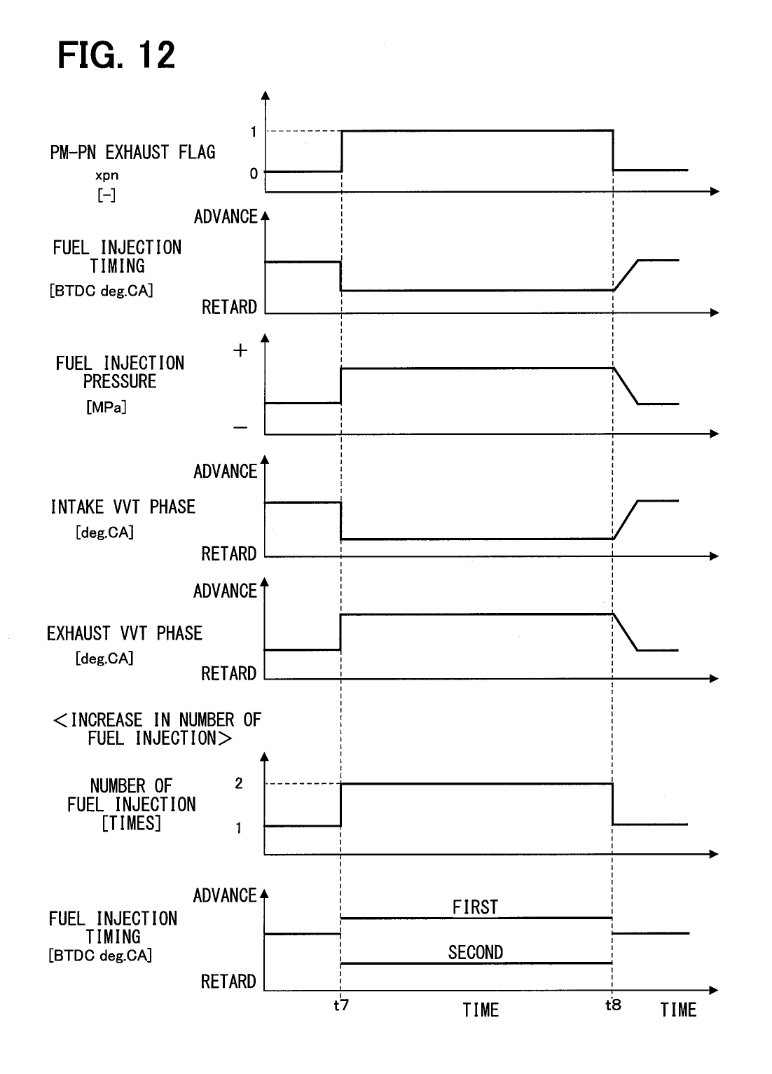

Next, processing in a case where the state in the cylinder 50 is estimated to be “the high temperature state” will be described with reference to FIG. 12. In this case, when the operation state of the engine 1 is brought into the PM-PN exhaust state at a time t7 and “1” is set to the PM-PN exhaust flag “xpn”, the ECU 24 changes the fuel injection timing to the retard side. In this way, the fuel can be injected in a state where a volume of the combustion chamber 54 is large. Hence, heat in the cylinder 50 can be removed by the injected fuel, which can hence reduce the temperature in the cylinder 50.

Further, the ECU 24 controls the high-pressure pump 13 in such a way that the fuel injection pressure is increased. In this way, the fuel injected at a high pressure from the fuel injector 16 can be reduced in a particle diameter and hence can easily remove the heat in the cylinder 50. Hence, it is possible to reduce the temperature in the cylinder 50.

Still further, the ECU 24 restricts the internal EGR of the engine 1. Specifically, the ECU 24 regulates the variable valve timing mechanisms 30, 31 in such a way that the valve timing of the intake valve 28 is changed to the retard side and that the valve timing of the exhaust valve 29 is changed to the advance side. In this way, the exhaust of the exhaust gas from the interior of the cylinder 50 to the exhaust port 52 side can be advanced, which can hence reduce the temperature in the cylinder 50.

Still further, the ECU 24 increases the number of injections of the fuel in one intake stroke, thereby being able to eliminate “the high temperature state”. In this case, the ECU 24 increases the number of injections of the fuel, which is one in one intake stroke until then, to two after the operation of the engine 1 is brought into the PM-PN exhaust state. In this way, the fuel injected from the fuel injector 16 can be further reduced in the particle diameter and hence can easily remove the heat in the cylinder 50, which can hence reduce the temperature in the cylinder 50.

When the operation state of the engine 1 ceases to be the PM-PN exhaust state at a time t8 and “0” is set to the PM-PN exhaust flag “xpn”, the ECU 24 returns the control values of the respective actuators to those of the normal control.

The embodiment of the present disclosure has been described above with reference to the specific examples. However, the present disclosure is not limited to these specific examples. In other words, an embodiment in which a person skilled in the art adds an appropriate design change to these specific examples described above is also included in the scope of the present disclosure as far as the embodiment has a feature of the present disclosure. The respective elements, arrangements, materials, conditions, shapes, and sizes included by the respective specific examples described above are not limited to those described above but can be appropriately modified.

1. A control apparatus that controls an internal combustion engine mounted in a vehicle to directly inject fuel into a cylinder, the control apparatus comprising:
a PM-PN exhaust determination part that determines whether or not an operation state of the internal combustion engine is a PM-PN exhaust state in which a particulate matter generated due to a fuel combustion in the cylinder is increased as compared with other operation states; and
a control value calculation part that calculates a control value of an actuator to regulate at least one of a fuel injection timing, a number-of-injections of the fuel, a fuel injection pressure, an intake valve timing, and an exhaust valve timing of the internal combustion engine,
wherein
the control value calculation part includes an in-cylinder state estimation part that estimates a state to which the cylinder belongs between a plurality of PM-PN generation states, the plurality of PM-PN generation states being states in which the particulate matter is easily generated as compared with the other state, and being different from each other in a cause to generate the particulate matter, and
in a case where the operation state of the internal combustion engine is determined to be the PM-PN exhaust state, the control value calculation part calculates the control value in such a way to eliminate the PM-PN generation state according to the PM-PN generation state to which the state in the cylinder belongs.

2. A control apparatus according to claim 1, wherein
the PM-PN exhaust determination part determines whether or not the vehicle is in an acceleration state, and
in a case where the vehicle is in the acceleration state, the PM-PN exhaust determination part determines that the internal combustion engine is in the PM-PN exhaust state.

3. A control apparatus according to claim 2, wherein
the PM-PN exhaust determination part determines that the vehicle starts the acceleration state on the basis of an increase in an accelerator opening of the vehicle.

4. A control apparatus according to claim 2, wherein
the PM-PN exhaust determination part determines that the vehicle finishes the acceleration state on the basis of a decrease in a quantity of the fuel injected into the cylinder.

5. A control apparatus according to claim 1, wherein
the in-cylinder state estimation part estimates the PM-PN generation state to which the cylinder belongs between a WET state, a nonuniform state, and a high temperature state,
the WET state is a state in which the fuel easily exists in a liquid state in the cylinder as compared with the nonuniform state and the high temperature state,
the nonuniform state is a state in which a concentration of the fuel easily becomes nonuniform in the cylinder as compared with the WET state and the high temperature state, and
the high temperature state is a state in which a temperature in the cylinder easily becomes high as compared with the WET state and the nonuniform state.

6. A control apparatus according to claim 5, wherein
in a case where the temperature in the cylinder is comparatively high, a range in which the in-cylinder state estimation part estimates that the state in the cylinder is the WET state is smaller than in a case where the temperature in the cylinder is comparatively low.

7. A control apparatus according to claim 5, wherein
in a case where the state in the cylinder is estimated to be the WET state, the control value calculation part calculates the control value in such a way as to increase the temperature in the cylinder.

8. A control apparatus according to claim 7, wherein
in a case where the state in the cylinder is estimated to be the WET state, the control value calculation part calculates the control value in such a way that the fuel injection pressure of the internal combustion engine is reduced as compared with a case where the state in the cylinder is not the WET state.

9. A control apparatus according to claim 5, wherein
in a case where the state in the cylinder is estimated to be the nonuniform state, the control value calculation part calculates the control value in such a way that the fuel injection timing of the internal combustion engine is advanced as compared with a case where the state in the cylinder is not the nonuniform state.

10. A control apparatus according to claim 5, wherein
in a case where the state in the cylinder is estimated to be the high temperature state, the control value calculation part calculates the control value in such a way that the fuel injection timing of the internal combustion engine is retarded as compared with a case where the state in the cylinder is not the high temperature state.

11. A control apparatus according to claim 5, wherein
in a case where the state in the cylinder is estimated to be the high temperature state, the control value calculation part retards the intake valve timing and advances the exhaust valve timing as compared with a case where the state in the cylinder is not the high temperature state.
